(19) United States
(12) Patent Application Publication
(10) Pub. No.: US 2024/0400022 A1
(43) Pub. Date: Dec. 5, 2024

(54) TRAILED VEHICLE HAVING A BRAKE SYSTEM

(71) Applicant: Dexter Axle Company LLC, Elkhart, IN (US)

(72) Inventors: Samuel Neil Lievore, Elkhart, IN (US); Eric Joseph Schuh, Stevensville, MI (US)

(21) Appl. No.: 18/327,517

(22) Filed: Jun. 1, 2023

(51) Int. Cl. B60T 13/66; B60T 1/06; B60T 8/176; B60T 13/20; B62D 63/08

(52) U.S. Cl. CPC B60T 13/662; B60T 1/065; B60T 8/176; B60T 13/20; B62D 63/08; B60T 2270/10

(57) ABSTRACT

A trailed vehicle is configured for coupling with a motor vehicle and is adapted to be towed by the motor vehicle. The trailed vehicle includes a frame. At least one axle is rotatably coupled to the frame and carries a pair of wheels. A hydraulic brake system is operably coupled with the motor vehicle and with the wheels of the trailed vehicle. The hydraulic brake system includes a caliper assembly and a manifold assembly provided with the wheels of the trailed vehicle.

### BACKGROUND

Contemporary approaches for towing trailed vehicles, such as trailers, caravans, campers, or recreational vehicles (RVs), by a towing vehicle, such as a truck or other suitable motor vehicle, include the use of brake systems or braking assemblies of various types, configurations, and designs. Such brake systems are provided in communication with the towing vehicle and configured for controlling brakes included with the trailed vehicle to be towed, itself. Trailed vehicles include a chassis or frame and at least one axle carrying at least one pair of wheels for supporting the chassis. A tongue extends from the chassis for coupling with the towing vehicle via a trailer hitch assembly. The brake system operably couples the towing vehicle with at least one of the wheels of the trailed vehicle.

By way of non-limiting example, in cases where the trailed vehicle to be towed includes its own brakes, control of braking pressure or strength, implementation or actuation of brake operation, and the proper proportioning of the brakes of the trailed vehicle, such as proportioning the gain of the brakes in response to a weight of the vehicle, a weight of the trailer, and/or a payload of the trailer, whether in a loaded condition or an unloaded condition, can be set. Such parameters and operations of the brake systems to be set can be determined or controlled with respect to the trailed vehicle as a whole, such as to all of the wheels or axles of the trailed vehicle, or to less than all of the wheels or axles of the trailed vehicle. If the brakes of the trailed vehicle exert too much force, the trailed vehicle may exert too much braking force and jerk the towing vehicle through over-application or potentially lock the wheels of the trailed vehicle. If the brakes of the trailed vehicle exert too little force, the brakes on the towing vehicle may be overworked because the brakes of the trailed vehicle are contributing too little. As such, there is a need for brake systems that ensure or improve the proper control and operation of the brakes of the trailed vehicle.

### BRIEF DESCRIPTION

An aspect of the present disclosure relates to a trailed vehicle configured for coupling with a motor vehicle and adapted to be towed by the motor vehicle, the trailed vehicle comprising a frame, at least one axle rotatably coupled to the frame and carrying a pair of wheels, and a hydraulic brake system operably coupled with the motor vehicle and with each of the wheels of the trailed vehicle, the hydraulic brake system comprising a caliper assembly provided with each of the wheels of the trailed vehicle and having at least one piston, and a manifold assembly provided with each of the wheels of the trailed vehicle and having a pump and a motor, wherein the manifold assembly is provided with and coupled to the caliper assembly.

Another aspect of the present disclosure relates to a trailed vehicle configured for coupling with a motor vehicle and adapted to be towed by the motor vehicle, the trailed vehicle comprising a frame, at least one axle rotatably coupled to the frame and carrying a pair of wheels, and a hydraulic brake system operably coupled with the motor vehicle and with at least one of the wheels of the trailed vehicle, the hydraulic brake system comprising a caliper assembly provided with the at least one of the wheels of the trailed vehicle and having at least one piston, and a manifold assembly provided with the at least one of the wheels of the trailed vehicle and having a pump and a motor, wherein the manifold assembly is provided with and directly coupled to the caliper assembly.

Yet another aspect of the present disclosure relates to a trailed vehicle configured for coupling with a motor vehicle and adapted to be towed by the motor vehicle, the trailed vehicle comprising a frame, at least one axle rotatably coupled to the frame and carrying a pair of wheels, and a hydraulic brake system operably coupled with the motor vehicle and with at least one of the wheels of the trailed vehicle, the hydraulic brake system comprising a caliper assembly provided with the at least one of the wheels of the trailed vehicle, the caliper assembly comprising a caliper housing, and a plurality of pistons carried by the caliper housing, and at least one manifold assembly provided with the at least one axle of the trailed vehicle and having a pump and a motor, wherein the manifold assembly is operably coupled to the caliper assembly such that the pump is fluidly coupled to each piston of the plurality of pistons.

### BRIEF DESCRIPTION OF THE DRAWINGS

In the drawings:

FIG. 1 is a schematic block diagram of a tow vehicle coupled with a trailed vehicle, illustrated herein as a trailer, by a trailer hitch assembly, and systems and components for operably coupling the tow vehicle and the trailer.

FIG. 2 is a schematic block diagram of an example of a brake system for use with the tow vehicle and trailer of FIG. 1 and including at least one wheel and at least one wheel brake assembly.

FIG. 3 is a schematic block diagram of another example of a hydraulic brake system for use with the tow vehicle and trailer of FIG. 1 and including the at least one wheel and another example of at least one wheel brake assembly.

FIG. 4 is a perspective view of a wheel brake assembly for use with the at least one wheel and the hydraulic brake system of FIG. 3 and including a mounting bracket, a manifold assembly, and a caliper assembly.

FIG. 5 is an exploded perspective view of the wheel brake assembly of FIG. 4, including the mounting bracket, the manifold assembly, and the caliper assembly.

FIG. 6 is another exploded perspective view of the wheel brake assembly of FIG. 4, including the mounting bracket, the manifold assembly, and the caliper assembly.

FIG. 7 is a partially exploded perspective view of the caliper assembly of FIG. 4.

FIG. 8 is a perspective view of a portion of the assembled wheel brake assembly of FIG. 4, including the manifold assembly and the caliper assembly, but with the mounting bracket removed.

FIG. 9 is a cross-sectional view of a portion of the wheel brake assembly of FIG. 4, including the manifold assembly, taken along line IX-IX of FIG. 8.

FIG. 10 is a cross-sectional view of a portion of the wheel brake assembly of FIG. 4, including the manifold assembly and the caliper assembly, taken along line X-X of FIG. 8.

FIG. 11 is a cross-sectional view of a portion of the wheel brake assembly of FIG. 4, including the manifold assembly and the caliper assembly, taken along line XI-XI of FIG. 8.

FIG. 12 is a perspective view of another example of a wheel brake assembly for use with the at least one wheel and the hydraulic brake system of FIG. 3 and including a mounting bracket, a manifold assembly, and a caliper assembly.

### DETAILED DESCRIPTION

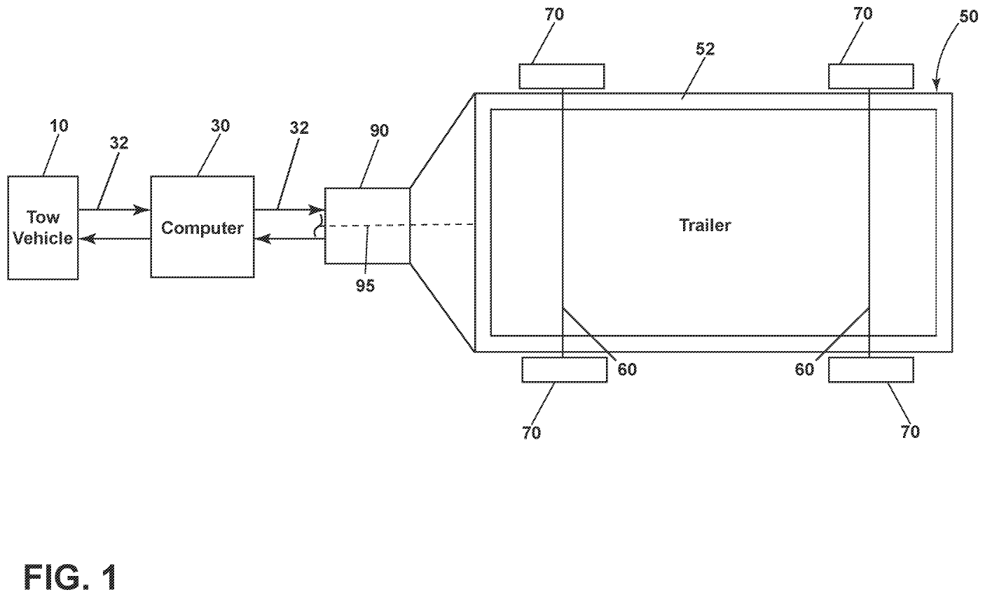

FIG. 1 schematically illustrates a motor vehicle, illustrated herein as a tow vehicle 10, capable of towing a trailed vehicle, illustrated herein as a trailer 50. It will be understood that the present disclosure is applicable to any suitable type of motor vehicle capable of towing the trailer 50, non-limiting examples of which include automobiles, trucks, sports utility vehicles (SUVs), or semi cabs having varying configurations, sizes, and towing capacities. Further, it will be understood that the present disclosure is applicable to any suitable type of trailed vehicle, non-limiting examples of which include cargo trailers, utility trailers, other types of trailers, caravans, campers, RVs, or other pull-behind vehicles having varying configurations, sizes, and weights. The tow vehicle 10 and trailer 50 share many features of conventional vehicles and trailers, respectively, which may not be described in detail herein, except as necessary for a complete understanding of aspects of the present disclosure.

Operational and electrical systems of the tow vehicle 10 can send and/or receive signals 32 to and from various components on the trailer 50, such as in response to actions taken by the tow vehicle 10 or by controllers in the tow vehicle 10. Such signals 32 may be passed through a device, such as a computer 30, that can be used to read and transmit the signals 32. The computer 30 can be integrated into the tow vehicle 10 or be located on the trailer 50.

The trailer 50 comprises a chassis or a frame 52. At least one axle 60 is rotatably coupled to the frame 52 and configured to at least partially support the frame 52. The at least one axle 60 carries at least one wheel 70, illustrated herein as a set or pair of two wheels 70 coupled to opposing ends of the at least one axle 60. While the illustrated example shows the trailer 50 including two axles 60, with each of the axles 60 carrying a set of two wheels 70, it will be understood that this is not limiting. The trailer 50 can include any suitable number of axles 60, including only a single axle 60, or more than two axles 60. Further, each of the axles 60 can carry any suitable number of wheels 70, including that more than one wheel 70 can be mounted to each end of the axles 60. Further yet, in the case that the trailer 50 includes more than one axle 60, it will be understood that each of the axles 60 can include the same number of wheels 70, or at least one of the axles 60 can carry a different number of wheels 70 than at least one other axle 60.

The trailer 50 is adapted to be towed by the tow vehicle 10 and configured to be selectively operably coupled to the tow vehicle 10 via a trailer hitch assembly 90. The trailer hitch assembly 90 is configured to allow the trailer 50 attached to the trailer hitch assembly 90 to be freely movable in orientation, with respect to the trailer hitch assembly 90 and to the tow vehicle 10 to which the trailer hitch assembly 90 is attached. The trailer hitch assembly 90 can additionally electrically couple the tow vehicle 10 and the trailer 50, such that the signals 32 transmitted between the tow vehicle 10 and the trailer 50 can be passed through the trailer hitch assembly 90. By way of non-limiting example, at least one of the trailer 50 and the trailer hitch assembly 90 further comprises a main communications bus 95 provided with the trailer 50 and with at least a portion of the main communications bus 95 coupled with, carried by, or at least partially received or housed within the trailer hitch assembly 90 for connection to a portion of the tow vehicle 10, in order to electrically couple the tow vehicle 10 and the trailer 50, such that the signals 32 transmitted between the tow vehicle 10 and the trailer 50 pass through the trailer hitch assembly 90 via the main communications bus 95.

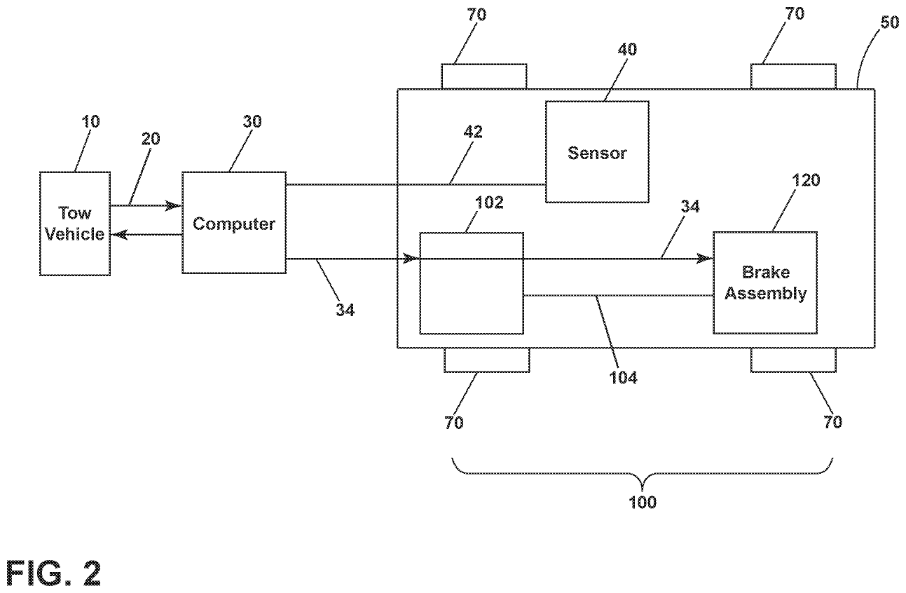

Turning now to FIG. 2, by way of non-limiting example, the signals 32 transmitted between the tow vehicle 10 and the trailer 50 can include brake signals that can be transmitted within a braking system, which can be provided as a variety of types and configurations for suitable braking systems, to effect braking of the trailer 50. At least one wheel brake assembly 120 is provided with the trailer 50, such that at least one of the wheels 70 of the trailer 50 is provided with a wheel brake assembly 120 configured for selectively braking the at least one of the wheels 70. The exemplary brake system 100 schematically illustrated in FIG. 2 comprises the at least one wheel brake assembly 120 and can be thought of as an electrical brake system 100 configured to send electrical signals to the at least one wheel brake assembly 120 on the trailer 50 to brake the at least one wheel 70, such as in response to actions, including decelerating or accelerating, taken by the tow vehicle 10 or a brake controller (not shown) of the tow vehicle 10. In the brake system 100, the tow vehicle 10 exerts a force 20 that is sent to the computer 30. The computer 30 then sends an electrical voltage, such as an electrical brake signal 34, directly to the at least one wheel brake assembly 120 to actuate the at least one wheel brake assembly 120 to apply a corresponding braking force to the corresponding wheel 70.

As a lighter trailer 50 requires less braking force, while a heavier trailer 50 requires relatively more braking force, the gain of the electrical brake signal 34 to the at least one wheel brake assembly 120 must be increased with a heavier trailer 50, in order to effectively brake the trailer 50. Thus, the brake system 100 can include at least one sensor 40 that can provide an input to the computer 30 indicative of a weight of the trailer 50 or its payload, non-limiting examples of which include a weight sensor, a strain gauge, or the like. The at least one sensor 40 is provided at any suitable location on the trailer 50, such as being located with or positioned on at least one of the axles 60 or on at least one of the wheels 70 of the trailer 50. A sensor signal 42 from the at least one sensor 40 can be passed through the computer 30 to determine a weight of the trailer 50 based on the sensor signal 42, which is used to dynamically determine an appropriate gain or braking force to be provided to the at least one wheel brake assembly 120 as the electrical brake signal 34, based on the sensor signal 42 from the sensor 40 indicative of the instantaneous weight of the trailer 50. In this way, the computer 30 reads the sensor signal 42 and can calculate the additional gain or braking force required to match any increased weight of the trailer 50 to continuously optimize performance of the brake system 100.

Optionally, the brake system 100 can further comprise a brake system actuator, separate from and in addition to the computer 30, illustrated herein as a brake system controller 102, operably and communicatively coupled with the computer 30 and with the at least one wheel brake assembly 120. In this case, rather than the computer 30 providing the electrical brake signal 34 directly to the at least one wheel brake assembly 120, the computer 30 instead provides the electrical brake signal 34 first to the brake system controller 102, with the brake system controller 102 in turn providing the electrical brake signal 34 to the at least one wheel brake assembly 120, such as, by way of non-limiting example, via electrical wiring 104.

In the case that more than one of the wheels 70 of the trailer 50 includes a wheel brake assembly 120, it will be understood that the computer 30 and the brake system controller 102 can provide the electrical brake signal 34 uniformly to each of the wheel brake assemblies 120, or can provide the electrical brake signal 34 independently to each of the wheel brake assemblies 120, such that differing electrical brake signals 34 can be provided to different wheel brake assemblies 120, allowing for further control and optimization of braking of the trailer 50 at individual wheels 70. In one non-limiting example, each wheel 70 of the trailer 50 is provided with a dedicated wheel brake assembly 120 and the computer 30 and the brake system controller 102 provide independent electrical brake signals 34 separately to each individual wheel brake assembly 120 and wheel 70 via separate electrical wiring 104.

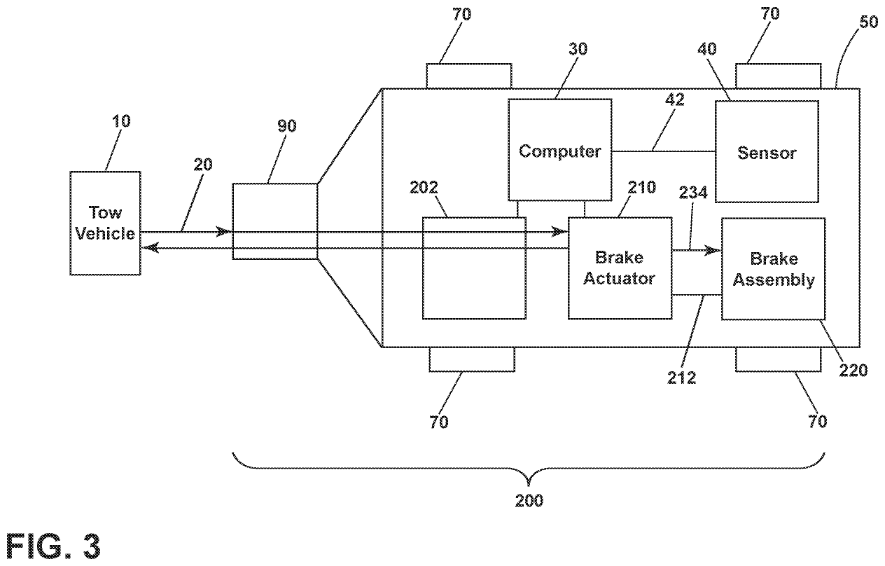

Another exemplary brake system 200, schematically illustrated in FIG. 3, comprises at least one wheel brake assembly 220 provided with the trailer 50, such that at least one of the wheels 70 of the trailer 50 is provided with the wheel brake assembly 220 configured for selectively braking the at least one of the wheels 70. The brake system 200 is provided as a hydraulic brake system 200 configured to send a braking signal to the at least one wheel brake assembly 220 on the trailer 50 to brake the at least one wheel 70, such as in response to actions, including decelerating or accelerating, taken by the tow vehicle 10 or a brake controller (not shown) of the tow vehicle 10. The braking signal of the hydraulic brake system 200 is provided to the at least one wheel brake assembly 220 in the form of hydraulic pressure, which can be thought of as a hydraulic brake signal 234, with a higher hydraulic pressure corresponding to a higher braking force and a lower hydraulic pressure corresponding to a relatively lower braking force.

While either one of the computer 30 or the brake system controller 102 is sufficient to generate the electrical brake signal 34 and actuate the electrical brake system 100, a different type of actuator, illustrated herein as a hydraulic brake actuator 210, for the hydraulics is needed to generate the hydraulic pressure for the hydraulic brake signal 234 within the hydraulic brake system 200. The hydraulic brake actuator 210 is located on the trailer 50 and is operably and communicatively coupled with the tow vehicle 10 and with the at least one wheel brake assembly 220. The hydraulic brake actuator 210 is adapted to generate hydraulic pressure to serve as the hydraulic brake signal 234 in response to a command signal or action of the tow vehicle 10. Both the action from the tow vehicle 10 or the command signal, such as from the computer 30, and the generation of the hydraulic pressure by the hydraulic brake actuator 210 are needed to provide the hydraulic brake signal 234 to the at least one wheel brake assembly 220, and can thus be thought of as collectively acting as a brake system actuator for the hydraulic brake system 200.

Optionally, a brake system controller 202, similar to the brake system controller 102 of the brake system 100, can further act as and form a portion of such a brake system actuator for the hydraulic brake system 200. The brake system controller 202 is operably and communicably coupled with the at least one wheel brake assembly 220. In one non-limiting example, the brake system controller 202 is provided separate from, and in addition to, the computer 30, and is further operably and communicatively coupled with the computer 30, though it will also be understood that the brake system controller 202 can be provided in place of the computer 30 or can additionally act as the computer 30. When the brake system controller 202 is included with the hydraulic brake system 200, both the action from the tow vehicle 10 or the command signal, such as from the computer 30, and the generation of the hydraulic pressure by the hydraulic brake actuator 210, along with the brake system controller 202, can thus be thought of as collectively acting as a brake system actuator to provide the hydraulic brake signal 234 for the hydraulic brake system 200.

In the operation of the hydraulic brake system 200, during acceleration or deceleration of the tow vehicle 10, the tow vehicle 10 exerts the force 20, such as by exerting the force 20 on the trailer hitch assembly 90, which is then passed on to the hydraulic brake actuator 210, such as via the main communications bus 95, and/or optionally via the brake system controller 202 and/or the computer 30. The hydraulic brake actuator 210 is operated to generate the appropriate hydraulic pressure and, in turn, to apply and provide the appropriate hydraulic pressure, as the hydraulic brake signal 234, directly to the at least one wheel brake assembly 220, such as, by way of non-limiting example, via fluid lines 212, and in proportion to the force 20 of the tow vehicle 10, to actuate the at least one wheel brake assembly 220 and apply the corresponding braking force to the corresponding wheel 70. In the case where the hydraulic brake system 200 includes both the brake system controller 202 and the computer 30, rather than the computer 30 or the trailer hitch assembly 90 providing the force or other actuation signal directly to the hydraulic brake actuator 210, the computer 30 or the trailer hitch assembly 90, via the main communications bus 95, instead provides the force or other actuation signal first to the brake system controller 202, with the brake system controller 202 in turn providing the actuation signal to the hydraulic brake actuator 210.

The hydraulic brake system 200 can also include the computer 30 and the at least one sensor 40, as described previously with respect to the brake system 100, such that the hydraulic pressure delivered by the hydraulic brake actuator 210 can be changed by the computer 30 based on the sensor signal 42 from the at least one sensor 40, which in turn changes the braking force applied at the at least one wheel brake assembly 220. Thus, like the brake system 100, the hydraulic brake system 200 likewise dynamically determines an appropriate gain or braking force to be provided to the at least one wheel brake assembly 220 as the hydraulic brake signal 234, based on the sensor signal 42 from the at least one sensor 40, as read by the computer 30, to match any increases or decreases in, or instantaneous measure of, the weight of the trailer 50 to continuously optimize performance of the hydraulic brake system 200.

In the illustrated example, the trailer 50, and thus also the hydraulic brake system 200, includes the single brake system controller 202 and the single hydraulic brake actuator 210 collectively serving to actuate the overall hydraulic brake system 200 in providing the hydraulic brake signal 234 to the at least one wheel brake assembly 220, such as via the fluid lines 212. In the case that more than one of the wheels 70 of the trailer 50, and up to all of the wheels 70 of the trailer 50, includes a wheel brake assembly 220, it will be understood that the brake system controller 202 and the hydraulic brake actuator 210 can act to provide the hydraulic brake signal 234 uniformly to each of the wheel brake assemblies 220, such that the same level of hydraulic pressure is provided to each of the wheel brake assemblies 220, or can provide the hydraulic brake signal 234 independently to each of the wheel brake assemblies 220, such that differing levels of hydraulic pressure can be provided to different wheel brake assemblies 220, allowing for further control and optimization of braking of the trailer 50 at individual wheels 70. In such a non-limiting example, each wheel 70 of the trailer 50 is provided with a dedicated wheel brake assembly 220, and the brake system controller 202, together with the hydraulic brake actuator 210, provides independently controlled hydraulic brake signals 234 separately to each individual wheel brake assembly 220 and each respective wheel 70 via separate dedicated fluid lines 212 coupling the hydraulic brake actuator 210 to each of the wheel brake assemblies 220.

Additionally, even further control and optimization of the braking of the trailer 50 at the individual wheels 70 within the hydraulic brake system 200 can be realized through various configurations of the brake system controller 202 and the hydraulic brake actuator 210 with respect to the at least one wheel brake assembly 220. In one non-limiting example, instead of having one hydraulic brake actuator 210 for the hydraulic brake system 200 that is operably coupled with multiple wheel brake assemblies 220 via the fluid lines 212, each of the wheels 70 of the trailer 50 can be provided with a dedicated wheel brake assembly 220, as well as with a dedicated hydraulic brake actuator 210. In this case, each wheel brake assembly 220 can be thought of as comprising the dedicated hydraulic brake actuator 210, such that the need for the fluid lines 212 may even be eliminated. Further by way of non-limiting example, it is contemplated that the hydraulic brake system 200 can still include the single brake system controller 202, with the single brake system controller 202 operably coupled with the dedicated wheel brake assembly 220 and dedicated hydraulic brake actuator 210 provided with each of the wheels 70, or that the hydraulic brake system 200 can further include a dedicated brake system controller 202 provided with the dedicated wheel brake assembly 220 and the dedicated hydraulic brake actuator 210 provided with each of the wheels 70, such that the multiple brake system controllers 202 are each individually operably coupled with the computer 30 or with the main communications bus 95 for individual operation at each wheel 70.

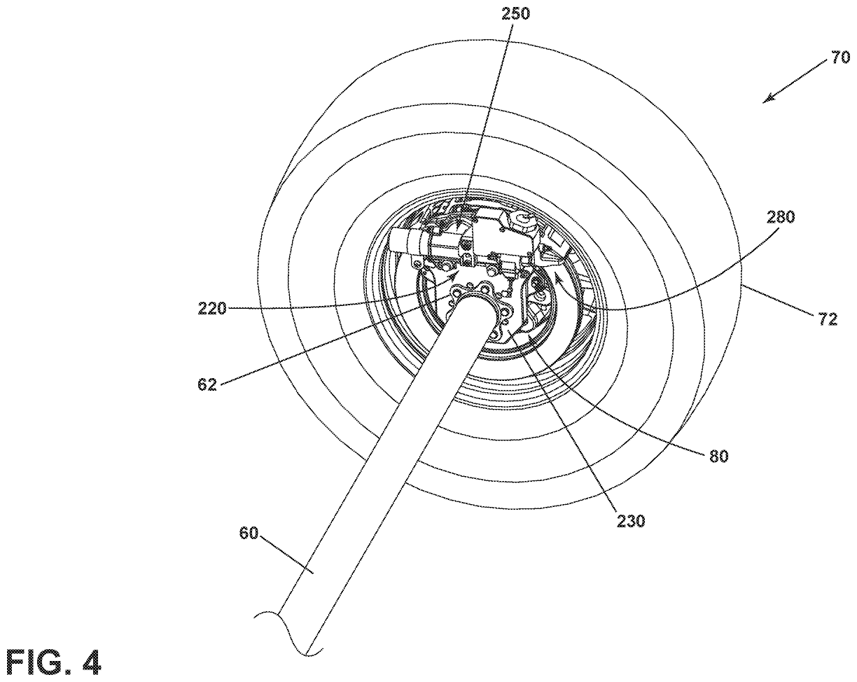

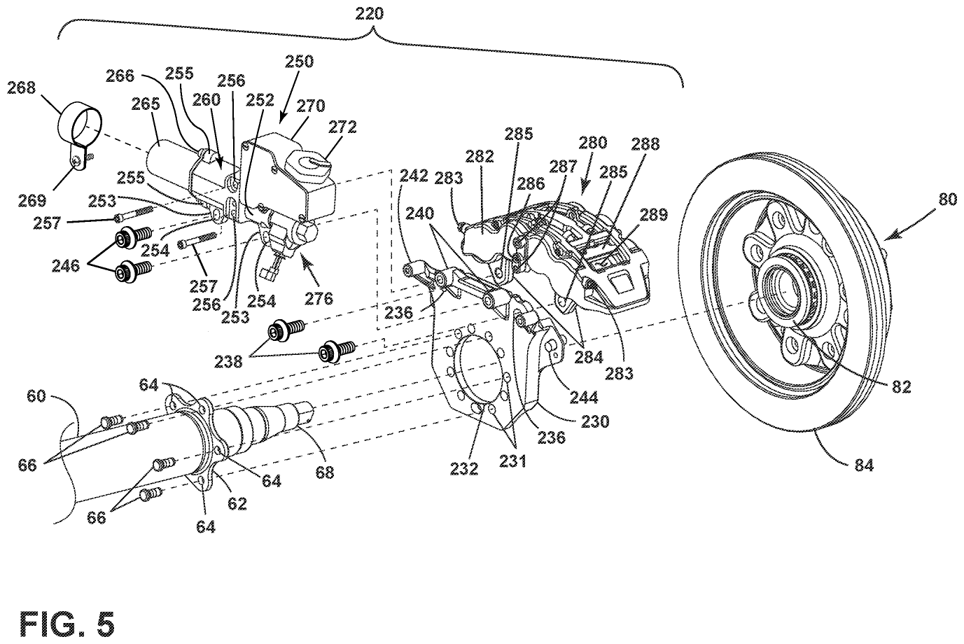

Turning now to FIG. 4, an exemplary wheel brake assembly 220 for use with the hydraulic brake system 200 is illustrated in further detail, with such wheel brake assembly 220 comprising the dedicated hydraulic brake actuator 210 provided with each of the wheels 70, within each wheel brake assembly 220. Each wheel 70 comprises a tire 72 mounted to a wheel hub 80. Each end of the axle 60 has an axle shaft 68 (FIG. 5) configured for coupling the axle 60 to the wheel 70, and specifically to the wheel hub 80 of the wheel 70. Further, each end of the axle 60 has an axle mount 62 configured for coupling the axle 60 to at least a portion of the wheel brake assembly 220, which can in turn be thought of as indirectly coupling the wheel brake assembly 220 to the wheel 70, via the axle 60, and specifically to the wheel hub 80 of the wheel 70.

The wheel brake assembly 220 comprises a mounting bracket 230 for coupling the wheel brake assembly 220 to the axle mount 62 of the axle 60, and therefore also to the wheel hub 80 of the wheel 70. In the illustrated example, the axle mount 62 is mounted directly to the mounting bracket 230, with the axle 60 in turn mounted with the wheel hub 80, such that the mounting bracket 230 is effectively coupled with the wheel hub 80 via the axle 60.

The wheel brake assembly 220 further comprises a manifold assembly 250, which serves and acts as the dedicated hydraulic brake actuator 210 for the wheel brake assembly 220 of each wheel 70, and a caliper assembly 280. Both the manifold assembly 250 and the caliper assembly 280 are mounted to and carried by the mounting bracket 230. Additionally, the manifold assembly 250 and the caliper assembly 280 are directly coupled with one another to collectively form at least a portion of the wheel brake assembly 220.

The exploded view of FIG. 5 illustrates the components of the wheel brake assembly 220 and the attachment with the axle 60 and with the wheel hub 80 in further detail. The axle mount 62 defines a plurality of fastener openings 64 adapted to each receive an axle fastener 66 for coupling the axle mount 62 to the mounting bracket 230. The axle shaft 68 extends longitudinally outwardly from the axle 60, extending beyond the axle mount 62. The wheel hub 80 comprises an axle receiver 82 configured to at least partially receive the axle shaft 68 and to mount the wheel hub 80 to the axle shaft 68. The wheel hub 80 further comprises a braking disc 84 at least partially surrounding the axle receiver 82 and configured to further couple the wheel hub 80 with at least a portion of the wheel brake assembly 220, such as via selective interaction with the caliper assembly 280.

The mounting bracket 230 defines an axle opening 232 through which a portion of the axle 60, such as the axle shaft 68, can pass to reach the axle receiver 82 of the wheel hub 80, such that the axle opening 232 surrounds the circumference of the axle 60 or the axle shaft 68. A plurality of axle fastener openings 231 are arranged about the axle opening 232 and positioned so as to receive the axle fasteners 66 to fasten the axle mount 62 to the mounting bracket 230. The mounting bracket 230 further comprises a pair of caliper fastener openings 236, a pair of manifold mounting bosses 240, and at least one secondary mounting boss 242. The caliper fastener openings 236 are adapted to each receive a caliper fastener 238 for mounting the caliper assembly 280 to the mounting bracket 230. The manifold mounting bosses 240 are adapted to each receive a manifold fastener 246 for mounting the manifold assembly 250 to the mounting bracket 230. The mounting bracket 230 can optionally further carry at least one sensor assembly 244 associated with the wheel brake assembly 220.

The manifold assembly 250 comprises a manifold, illustrated herein as a manifold housing 252, with a brake fluid reservoir 270 having a reservoir lid 272 and a valve assembly 276 coupled to and carried by the manifold housing 252. The manifold housing 252 comprises a pair of mounting flanges 253 extending from a lower portion of the manifold housing 252 and each defining a manifold mounting opening 254 each adapted to receive one of the manifold fasteners 246 for mounting the manifold assembly 250 to the mounting bracket 230 at the manifold mounting bosses 240. The manifold housing 252 further comprises a pair of coupling fastener openings 256 adapted to each receive a coupling fastener 257 for coupling the manifold assembly 250 to at least a portion of the caliper assembly 280. The manifold housing 252 further receives and houses a pump, illustrated herein as a pump assembly 260, adjacent which the manifold housing 252 defines a pair of motor mounting bosses 255.

A motor 265 further forms a portion of the manifold assembly 250 and is coupled to the pump assembly 260 and the manifold housing 252 by motor fasteners 266 that couple to the motor mounting bosses 255. The motor 265 is operably coupled with the pump assembly 260 to drive operation of the pump assembly 260. A motor clamp 268 is provided about at least a portion of the periphery of the motor 265 and includes a clamp fastener 269 configured for attachment to the secondary mounting boss 242 on the mounting bracket 230 to couple the motor 265 to the mounting bracket 230, and to thus further couple the manifold assembly 250 to the mounting bracket 230.

The caliper assembly 280 comprises a caliper housing 282 defining at least one fluid line coupler 283, illustrated herein as a pair of fluid line couplers 283 positioned at opposing longitudinal ends of the caliper housing 282. The caliper housing 282 comprises a pair of caliper mounting flanges 284 extending from a lower portion of the caliper housing 282 and each defining a caliper mounting opening 285 each adapted to receive one of the caliper fasteners 238 for mounting the caliper assembly 280 to the mounting bracket 230 at the caliper fastener openings 236. The caliper housing 282 further comprises a pair of coupling fastener openings 287 adapted to each receive one of the coupling fasteners 257 for coupling the manifold assembly 250 to the caliper housing 282.

The caliper housing 282 further comprises a caliper fluid inlet 286 configured for coupling with a portion of the manifold assembly 250 for fluidly coupling the manifold assembly 250 with the caliper assembly 280, and specifically with the caliper housing 282. The caliper housing 282 at least partially receives and houses a caliper frame assembly 288. At least a portion of the caliper frame assembly 288 and at least a portion of the caliper housing 282 can be thought of as collectively forming at least a portion of a braking channel 289 defined at an interior portion of the caliper housing 282 and of the caliper frame assembly 288. The braking channel 289 can be sized and positioned so as to receive at least a portion of the braking disc 84 of the wheel hub 80 in order for the caliper assembly 280 to selectively engage with the braking disc 84 for applying a braking force to the wheel hub 80.

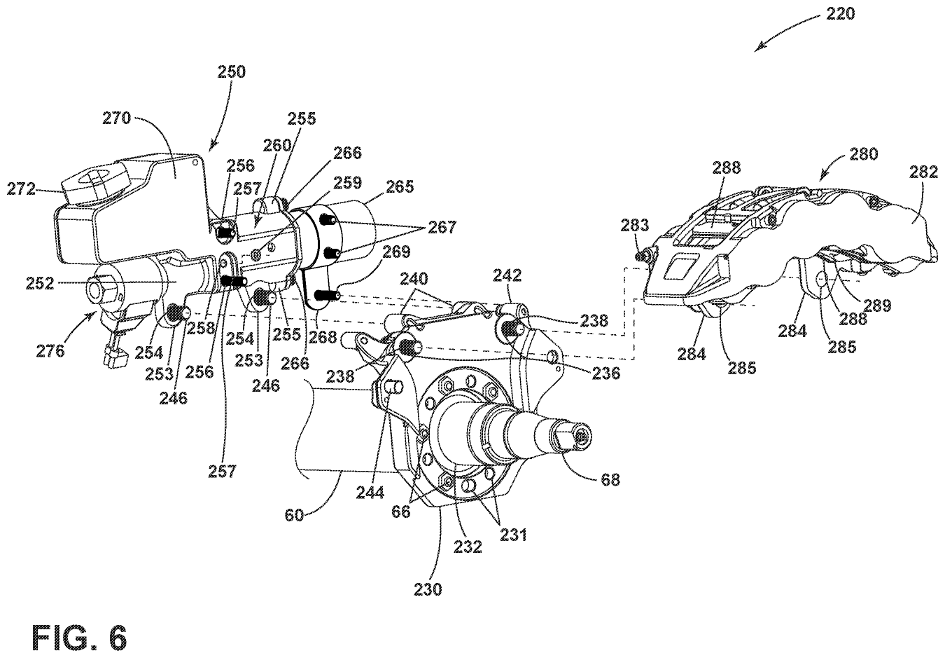

The exploded view of FIG. 6 shows portions of the wheel brake assembly 220 exploded, but from a rear or outer view of the wheel brake assembly 220 and with the wheel hub 80 removed for clarity. As illustrated, it can be seen that the axle shaft 68 extends through the axle opening 232 when the axle mount 62 (FIG. 5) is coupled to the mounting bracket 230 by the axle fasteners 66 attached to the axle fastener openings 231.

With respect to the manifold assembly 250, the manifold fasteners 246 are shown within the manifold mounting openings 254 and aligned with the mounting bracket 230 for coupling of the manifold fasteners 246 to the manifold mounting bosses 240. Likewise, the clamp fastener 269 is shown with the motor clamp 268 and aligned with the mounting bracket 230 for coupling of the clamp fastener 269 to the secondary mounting boss 242. It can be further seen in this view that the motor 265 further comprises at least one motor fastener 267, illustrated herein as a pair of motor fasteners 267, coupling the motor clamp 268 to the motor 265. The coupling fasteners 257 are shown within the coupling fastener openings 256 defines within the manifold housing 252 and aligned with the caliper assembly 280 for coupling of the coupling fasteners 257 to the coupling fastener openings 287 (FIG. 5) of the caliper housing 282 in order to directly couple the manifold assembly 250 to the caliper assembly 280 by directly coupling the manifold housing 252 to the caliper housing 282.

The view of FIG. 6 further illustrates that the manifold housing 252 further comprises a manifold fluid outlet 258, illustrated herein as being positioned vertically between the coupling fastener openings 256, and configured for coupling with a portion of the caliper assembly 280 for fluidly coupling the manifold assembly 250 with the caliper assembly 280. Specifically, the manifold fluid outlet 258 is configured for coupling with a portion of the caliper housing 282 for fluidly coupling the manifold housing 252 with the caliper housing 282 by aligning and fluidly coupling of the manifold fluid outlet 258 with the caliper fluid inlet 286 (FIG. 5). An O-ring 259 is provided with the manifold housing 252 and positioned to surround the manifold fluid outlet 258, the O-ring 259 configured to at least partially form and to seal an interface between the manifold fluid outlet 258 and the caliper fluid inlet 286.

In this way, when the coupling fasteners 257 mount the manifold assembly 250 to the caliper assembly 280, and specifically by directly coupling the manifold housing 252 to the caliper housing 282, the manifold fluid outlet 258 and the caliper fluid inlet 286 are, in turn, directly fluidly coupled with one another. As used herein, the terms ‘directly coupled’ or ‘directly fluidly coupled’ are taken to mean that the manifold fluid outlet 258 and the caliper fluid inlet 286 are coupled directly to one another without the need for intervening fluid lines 212 extending between the manifold assembly 250 and the caliper assembly 280.

With respect to the caliper assembly 280, the caliper fasteners 238 are shown within the caliper fastener openings 236 of the mounting bracket 230 and aligned with the caliper assembly 280 for coupling of the caliper fasteners 238 to the caliper mounting openings 285 of the caliper housing 282 through the caliper fastener openings 236 of the mounting bracket 230. Further, the positioning of the braking channel 289 at a lower and interior portion of the caliper assembly 280 can be better seen.

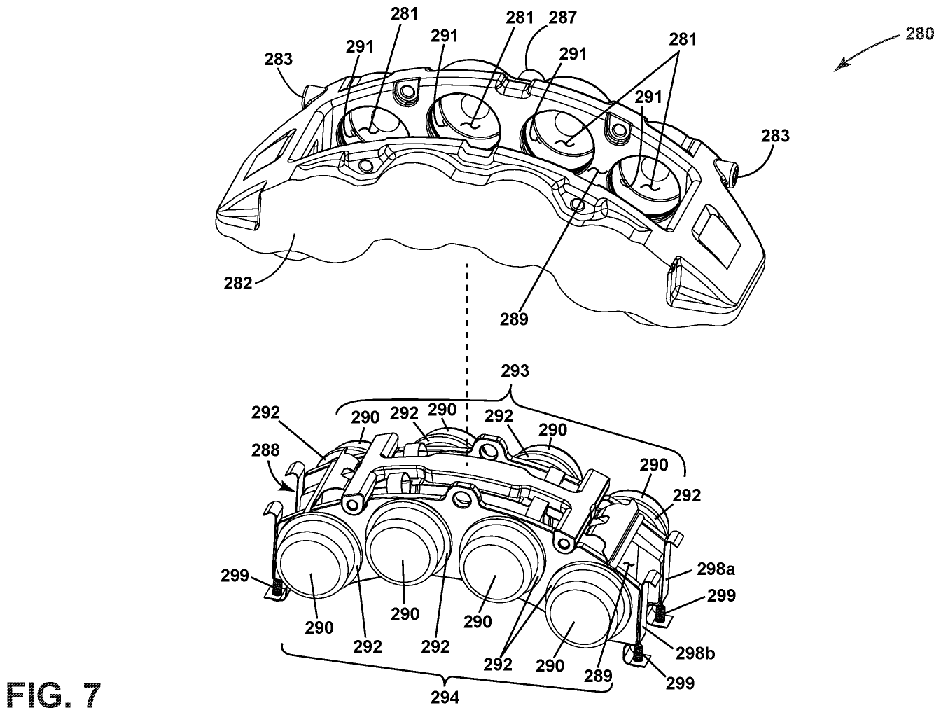

Turning now to FIG. 7, the exploded view better shows the detail of portions of the caliper assembly 280. The caliper frame assembly 288 comprises at least one longitudinally-extending support frame member, illustrated herein as a pair of frame elements comprising an inner frame member 298a and an outer frame member 298b. The inner frame member 298a is positioned nearer or proximal to the caliper fluid inlet 286 and the mounting bracket 230, while the outer frame member 298b is positioned further or distal from the caliper fluid inlet 286 and the mounting bracket 230. At least one frame fastener 299 couples each of the inner and outer frame members 298a, 298b to the caliper housing 282.

Each of the inner and outer frame members 298a, 298b are configured to support a plurality of pistons 290. As illustrated, each of the inner and outer frame members 298a, 298b support four pistons 290 arranged along a longitudinal length of the inner and outer frame members 298a, 298b. The pistons 290 coupled with the inner frame member 298a can be thought of as forming an inner row 293 of pistons 290, while the pistons 290 coupled with the outer frame member 298b can be thought of as forming an outer row 294 of pistons 290. Thus, the inner row 293 of pistons 290 and the inner frame member 298a are spaced from and opposing the outer row 294 of pistons 290 and the outer frame member 298b about the braking channel 289.

An O-ring or other suitable sealing member, illustrated herein as a seal 292 can be provided about each of the pistons 290 at the interface of the pistons 290 with the inner and outer frame members 298a, 298b. The caliper housing 282 further defines a plurality of piston cavities 281 corresponding with the plurality of pistons 290, such that each of the pistons 290 can be at least partially received within one of the piston cavities 281 of the caliper housing 282. Further, the seals 292 can fluidly seal the pistons 290 each within the corresponding piston cavity 281. Each of the piston cavities 281 further comprises at least one fluid opening 291 fluidly coupling the corresponding piston cavity 281 with the caliper fluid inlet 286, as will be described in further detail below.

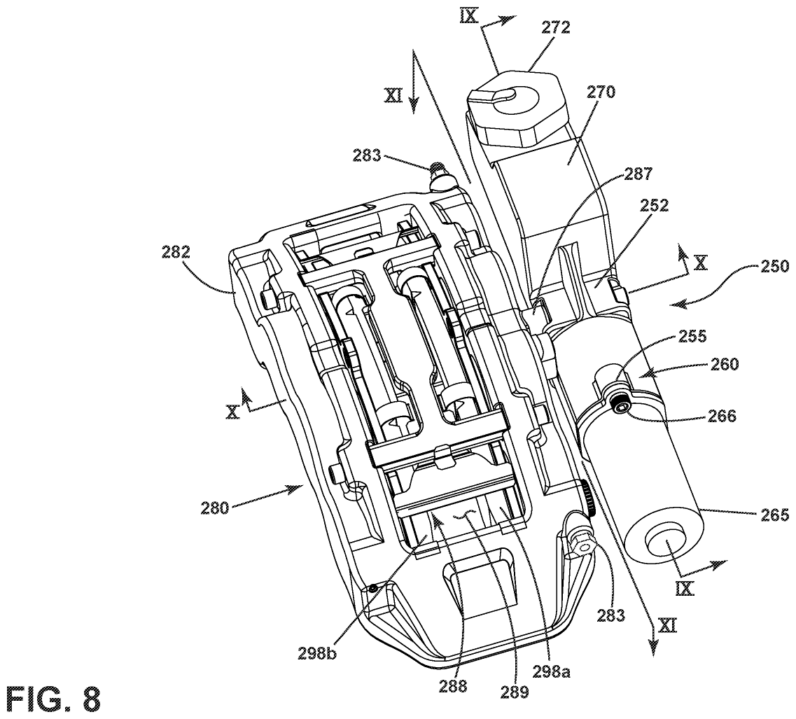

Turning now to FIG. 8, the manifold assembly 250 and the caliper assembly 280 are shown assembled with one another, and with the mounting bracket 230 removed for clarity. In this view, it can be seen that the manifold assembly 250 is provided with and coupled to the caliper assembly 280 within the wheel brake assembly 220, and specifically when the manifold housing 252 is mounted to the caliper housing 282 by the coupling fasteners 257 (FIG. 5-6), in order to directly fluidly couple the manifold assembly 250 with the caliper assembly 280 without the need for intervening or extending fluid lines 212 between them. In this way, at least a portion of the manifold assembly 250 is mounted to or at least partially carried by the caliper assembly 280, and, likewise, at least a portion of the caliper assembly 280 is mounted to or at least partially carried by the manifold assembly 250.

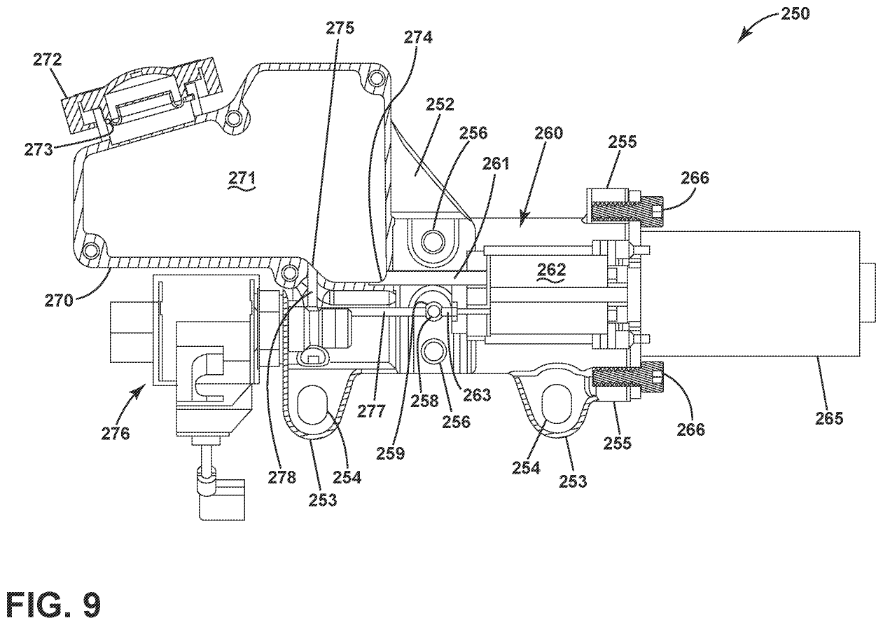

The cross-sectional view of FIG. 9 illustrates the internal components of the manifold assembly 250 in greater detail, as seen along sight line IX-IX of FIG. 8. The brake fluid reservoir 270 defines a reservoir cavity 271 configured for storing a volume of brake fluid and a fill opening 273 through which brake fluid can be introduced into the brake fluid reservoir 270, and specifically into the reservoir cavity 271. The reservoir lid 272 selectively couples to the fill opening 273 to selectively open and close the fill opening 273. The brake fluid reservoir 270 further defines a reservoir outlet 274 configured to be fluidly coupled to the pump assembly 260 and a reservoir return opening 275 configured to be fluidly coupled to the valve assembly 276.

The pump assembly 260 defined within the manifold housing 252 comprises a pump cavity 262, with a pump inlet 261 and a pump outlet 263 both fluidly coupled with the pump cavity 262. The pump inlet 261 is fluidly coupled with the reservoir outlet 274 of the brake fluid reservoir 270, such that the pump assembly 260 is configured to draw brake fluid from the reservoir cavity 271 of the brake fluid reservoir 270 and into the pump cavity 262 through the pump inlet 261. The pump outlet 263 is further fluidly coupled with the manifold fluid outlet 258, such that the pump assembly 260 is configured to provide brake fluid from the pump cavity 262 to the manifold fluid outlet 258 through the pump outlet 263.

The manifold fluid outlet 258 is further fluidly coupled with a valve inlet 277 of the valve assembly 276, such that brake fluid provided to the manifold fluid outlet 258 by the pump assembly 260 can selectively be provided either to exit the manifold assembly 250 through the manifold fluid outlet 258 or to flow from the manifold fluid outlet 258 to the valve assembly 276 through the valve inlet 277. The valve assembly 276 comprises the valve inlet 277 fluidly coupling the manifold fluid outlet 258 with the valve assembly 276, and further comprises a valve outlet 278 fluidly coupling the valve assembly 276 with the reservoir return opening 275 of the brake fluid reservoir 270. Thus, brake fluid that enters the valve inlet 277 from the manifold fluid outlet 258 is provided from the valve inlet 277 to the valve outlet 278 to be returned to the reservoir cavity 271 through the reservoir return opening 275.

In one example, when the valve assembly 276 is provided in a closed configuration, brake fluid that is supplied from the brake fluid reservoir 270 to the manifold fluid outlet 258 by the pump assembly 260 is prevented from flowing into the valve inlet 277, and instead is provided to the caliper assembly 280 through the manifold fluid outlet 258. When the valve assembly 276 is provided in an open configuration, or in a partially open configuration, brake fluid that is supplied from the brake fluid reservoir 270 to the manifold fluid outlet 258 by the pump assembly 260 is permitted to flow into the valve inlet 277, through the valve outlet 278, and to be returned into the reservoir cavity 271 through the reservoir return opening 275. It is also contemplated that a portion of the brake fluid can be provided to the caliper assembly 280 while a portion of the brake fluid is returned to the brake fluid reservoir 270, such as when the valve assembly 276 is provided in a partially opened configuration. Thus, the pump assembly 260 can be thought of as selectively providing, via the valve assembly 276, brake fluid either to the caliper assembly 280 or to be returned to the brake fluid reservoir 270.

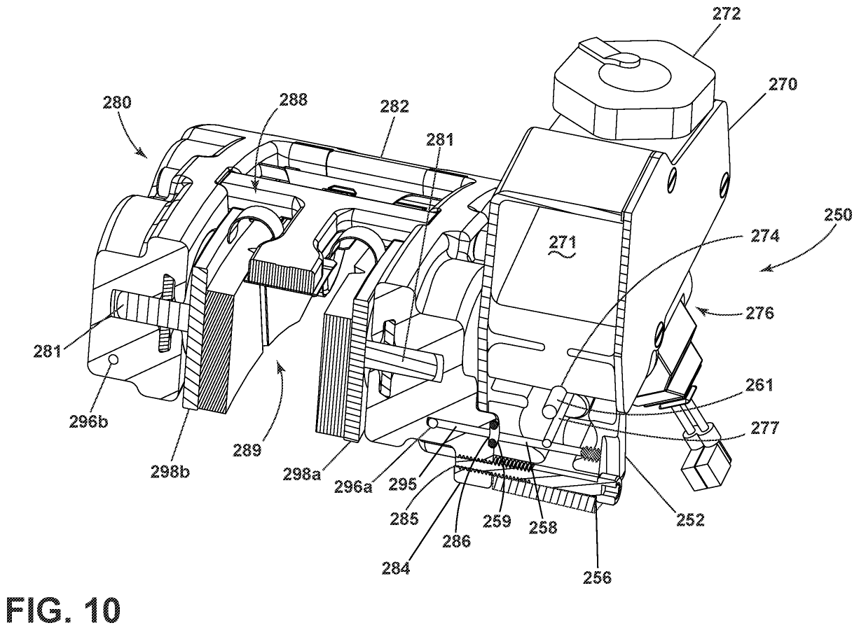

The cross-sectional view of FIG. 10 illustrates the interface between the manifold assembly 250 and the caliper assembly 280 in greater detail, as seen along sight line X-X of FIG. 8. When the manifold assembly 250 and the caliper assembly 280 are coupled together, the O-ring 259 forms the interface between the manifold fluid outlet 258 and the caliper fluid inlet 286, such that brake fluid can flow from the manifold assembly 250 through the manifold fluid outlet 258 and into the caliper assembly 280 through the caliper fluid inlet 286. The caliper housing 282 further defines a fluid flow circuit for brake fluid entering the caliper assembly 280 through the caliper fluid inlet 286, illustrated herein as comprising an inlet conduit 295 fluidly coupled to the caliper fluid inlet 286, and in turn fluidly coupled with at least an inner fluid conduit 296a and an outer fluid conduit 296b. The inner fluid conduit 296a is fluidly coupled to each piston cavity 281 of the inner row 293 (FIG. 7) of pistons 290 via the fluid openings 291 (FIG. 7) of the piston cavities 281, while the outer fluid conduit 296b is fluidly coupled to each piston cavity 281 of the outer row 294 (FIG. 7) of pistons 290 via the fluid openings 291 (FIG. 7) of the piston cavities 281. The inner fluid conduit 296a and the outer fluid conduit 296b are fluidly coupled to one another.

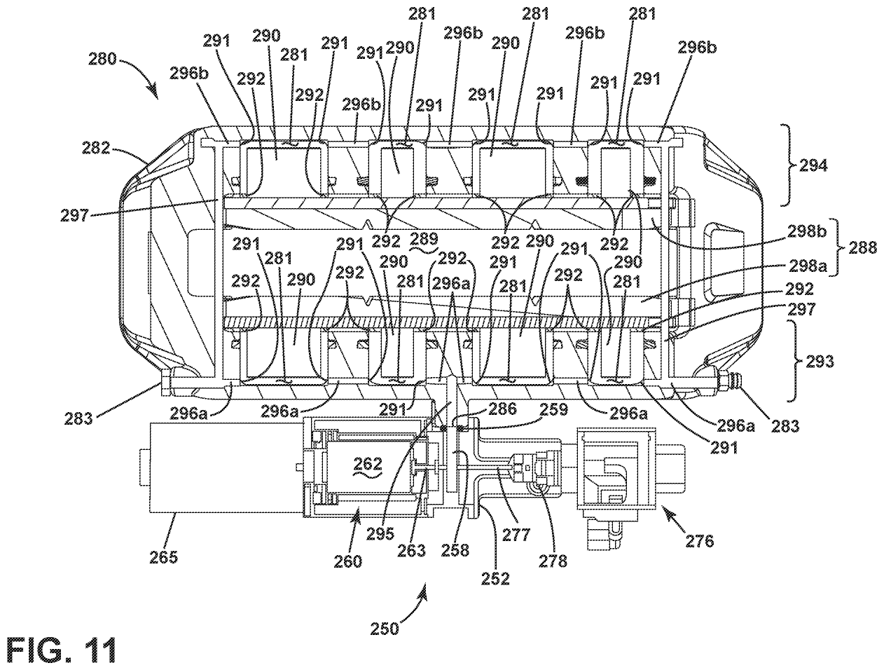

The cross-sectional view of FIG. 11 illustrates the fluid connections within the caliper assembly 280 in greater detail, as seen along sight line XI-XI of FIG. 8. It can be better seen that the piston cavities 281 each include two fluid openings 291 positioned at opposite sides of each piston cavity 281, with the inner fluid conduit 296a extending between the fluid openings 291 of each pair of adjacent piston cavities 281 for the inner row 293 of pistons 290 and the outer fluid conduit 296b extending between the fluid openings 291 of each pair of adjacent piston cavities 281 of the outer row 294 of pistons 290. As illustrated, the inner fluid conduit 296a can further optionally extend between and fluidly couple with the pair of fluid line couplers 283 on the caliper housing 282. At least one connecting conduit 297, illustrated herein as a pair of connecting conduit 297, extends between the inner fluid conduit 296a and the outer fluid conduit 296b. As illustrated, one connecting conduit 297 extends between the inner and outer fluid conduits 296a, 296b at one end of the caliper housing 282, while another connecting conduit 297 extends between the inner and outer fluid conduits 296a, 296b at the other end of the caliper housing 282.

Thus, the inlet conduit 295, and inner and outer fluid conduits 296a, 296b, and the connecting conduits 297 serve to fluidly couple the caliper fluid inlet 286 with the piston cavities 281 corresponding to each of the pistons 290 within the caliper assembly 280, thus also directly fluidly and operably coupling the manifold assembly 250 with each of the pistons 290, without the need for intervening fluid lines 212 extending between the manifold assembly 250 and the caliper assembly 280, such that the pump assembly 260 of the manifold assembly 250 is thus fluidly coupled with each of the pistons 290 and can be thought of as drawing brake fluid from the brake fluid reservoir 270 and selectively providing, via the valve assembly 276, the brake fluid to at least one piston 290 within the caliper assembly 280. The seals 292 provided with each of the pistons 290 ensure that the brake fluid is contained within the piston cavities 281 and does not leak to the braking channel 289 to contact the braking disc 84.

Turning now to the operation of the wheel brake assembly 220 within the hydraulic brake system 200, as described previously with respect to FIG. 3, in the case that each of the wheels 70 of the trailer 50 includes a dedicated wheel brake assembly 220, thus with a dedicated manifold assembly 250 and a dedicated caliper assembly 280 provided with each wheel 70, it is contemplated that all of the wheel brake assemblies 220 on the trailer 50 can be controlled by a single controller for the hydraulic brake system 200, such as the computer 30 or the brake system controller 202, or a dedicated controller can also be provided with the wheel brake assembly 220 of each wheel 70. In the case that the hydraulic brake system 200 comprises the single controller operably coupled with wheel brake assemblies 220 provided with each wheel 70, the brake system controller 202 will be referred to as such a single controller in the following non-limiting example, though it is understood that the computer 30 could also fill this role.

The brake system controller 202, in response to an input, signal, or action of the tow vehicle 10, is operably coupled with each wheel brake assembly 220 to deliver an actuation signal to each wheel brake assembly 220. Specifically, the brake system controller 202 is operably coupled to each manifold assembly 250, such as to each pump assembly 260 via the motor 265 provided with each wheel 70, to deliver the actuation signal to the manifold assembly 250 of each wheel brake assembly 220 and to cause actuation of the motor 265 to operate the pump assembly 260. Further, it is understood that the brake system controller 202 is configured to deliver separate actuation signals to the manifold assembly 250 of each wheel brake assembly 220, independently of one another, such that the actuation signals can be the same or can differ between the manifold assemblies 250 of different wheels 70.

In one non-limiting example, the actuation signal configured to be delivered from the brake system controller 202 is a pulse width modulation (PWM) signal. Such a PWM signal actuates operation of each motor 265, in turn actuating operation of each pump assembly 260. By varying the PWM signal delivered from the brake system controller 202, a fluid pressure generated by each pump assembly 260 can be adjusted or varied, either simultaneously with other pump assemblies 260 or independently of other pump assemblies 260. In another non-limiting example, the pump assembly 260 can be actuated to operate constantly, with the brake fluid flow and the braking pressure instead being modulated by the valve assembly 276, such as by the degree of opening of the valve assembly 276, to determine how much of the constantly pumped brake fluid goes to the pistons 290 and how much is returned to the brake fluid reservoir 270. Such a PWM signal can even be used in the context of anti-lock braking systems, such that the brake system controller 202 can be operably coupled with an anti-lock braking system of the tow vehicle 10 to deliver anti-lock braking signals to the wheel brake assemblies 220, even when each wheel 70 of the trailer 50 includes the dedicated wheel brake assembly 220.

It will also be understood that such operation of the wheel brake assemblies 220, whether with or without the inclusion of anti-lock braking capabilities, can be achieved through the use of a variety of suitable actuation signals, and is not limited to use with the PWM signal. Non-limiting examples of such additional suitable signal types or systems that can be used with the wheel brake assemblies 220 include local interconnect network (LIN) signals, such as LIN bus signaling, controller area network (CAN) signals, such as CAN bus signaling, serial signals, universal serial bus (USB) signaling, recommended standard 485 (RS-485) signaling, or recommended standard 232 (RS-232) signaling, etc. Specifically, in a further non-limiting example, the operation of the wheel brake assembly 220 and the brake system controller 202 comprises the use and delivery of actuation signals via a CAN bus for actuation of the at least one wheel brake assembly 220, such as for brake by wire operation. Such a CAN bus is configured to deliver actuation signals, such as, by way of non-limiting example, differential signals or channels, such as differential wired-AND signals, including CAN high (CANH) and CAN low (CANL).

In response to the actuation signal, brake fluid at the indicated fluid pressure generated by the pump assembly 260 is in turn provided to the pistons 290 of the caliper assembly 280. Another advantage of the hydraulic brake system 200 and the wheel brake assembly 220 is realized with the configuration of the pistons 290 within the caliper assembly 280. In conventional brake systems, a single piston may be provided with a single wheel 70, such a single piston often having a larger diameter or surface area and with a working pressure of 1600 pounds per square inch (PSI) and drawing enough amperage from the tow vehicle 10 for its operation that providing such a brake assembly or piston with each wheel may exceed the total amperage available from the tow vehicle 10 via the main communications bus 95. Thus, in order to accommodate the wheel brake assemblies 220 provided with each wheel 70 of the trailer 50, it is necessary to reduce the energy requirements of the wheel brake assemblies 220 compared to traditional implementations.

To this end, the plurality of pistons 290 provided within the caliper assembly 280 are provided with a smaller diameter and/or smaller surface area compared to a standard 1600 PSI brake piston, which may have a diameter of, by way of non-limiting example, approximately 2.25 inches. By providing a larger number of smaller pistons 290 arranged in series or in parallel within the caliper assembly 280, the total working pressure and power requirements of the caliper assembly 280 can be decreased, while still meeting the braking pressure requirements to achieve required stopping distances for the given trailer 50 and its payload for safely braking the trailer 50. The specific diameter, area, working pressure, and amperage drawn by each piston 290, as well as the number of pistons 290 provided within the caliper assembly 280, can be selected or customized to meet the braking requirements for a trailer 50 of a variety of sizes and configurations, and carrying a variety of payloads, such that the diameter, working pressure, and amperage drawn by each piston 290 is less than that of the standard brake piston, and further such that the number of pistons 290 provided within the caliper assembly 280 is greater than one.

By way of non-limiting example, it is contemplated that each piston 290 has a diameter that is less than the approximately 2.25 inches of the standard brake piston, further less than two inches, further less than 1.75 inches, and further yet approximately 1.6 inches or less, has a working pressure that is less than the approximately 1600 PSI of the standard brake piston, further less than 1000 PSI, further less than 600 PSI, and further yet approximately 500 PSI or less, and draws an amperage that is less than the approximately 40 amps of the standard brake piston, further less than 30 amps, further less than 7 amps, and further yet approximately 6 amps or less. Further by way of non-limiting example, it is contemplated that the combined, total working pressure of all of the pistons 290 included in the given caliper assembly 280 is less than the approximately 1600 PSI of the standard brake piston, further less than 1000 PSI, further less than 600 PSI, and further yet approximately 500 PSI or less, and that all of the pistons 290 included in the given caliper assembly 280 collectively draw a combined total amperage that is less than the approximately 40 amps of the standard brake piston, further less than 30 amps, further less than 7 amps, and further yet approximately 6 amps or less.

In the illustrated example, the plurality of pistons 290 of each caliper assembly 280, and therefore also of each wheel 70, can include eight pistons 290 having a roughly 1.6 inch diameter each for a total of roughly 16 square inches of piston area, sufficient to meet stopping distance requirements for the trailer 50, but that have a combined, total working pressure of roughly 500 PSI or less per caliper assembly 280, much less than the 1600 PSI standard piston, and can draw a combined total of only roughly 6 amps or less per caliper assembly 280, much less than the 30-40 amps typically drawn by a 1600 PSI standard piston to create enough brake pressure for achieving required stopping distances for the trailer 50. Thus, if the tow vehicle 10 provides a total power supply of 40 amps, the trailer 50 can include six separate wheels 70, each having the dedicated caliper assembly 280, and the amperage required for all six wheels 70 would still be within the available limit from the tow vehicle 10. It will be understood that the advantage of the wheel brake assembly 220 is not limited to a specific number or size of the pistons 290, but rather in that the number of pistons 290 used is larger than standard for the trailer 50 of any given size, and the relative size or diameter of these pistons 290 used is smaller than the same standard piston for the trailer 50 of any given size.

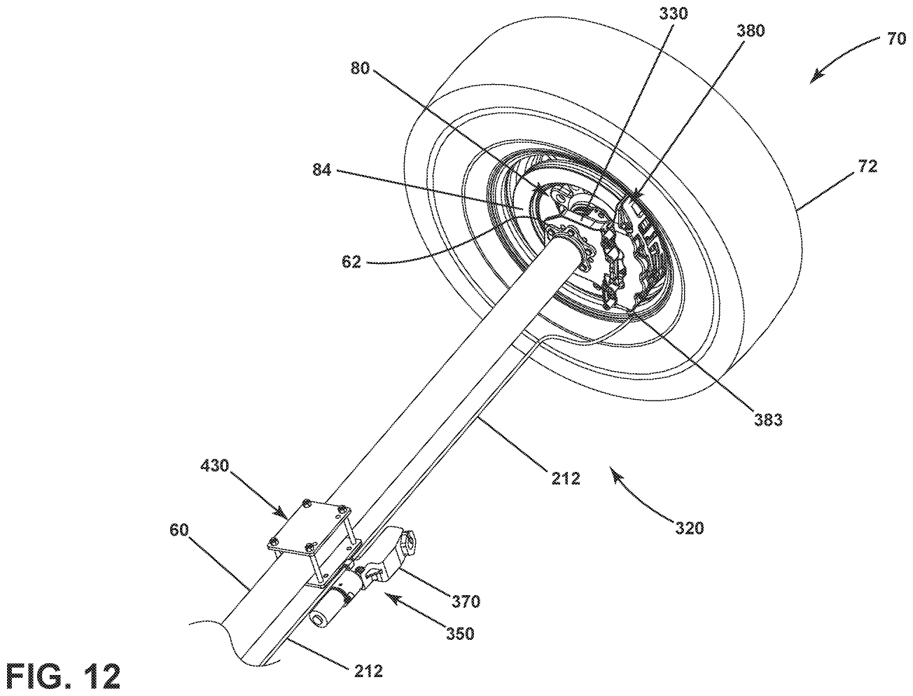

It will also be understood that the wheel brake assemblies 220 as described herein, and the configurations of the manifold assembly 250 and the caliper assembly 280 are not limited to use in a brake-per-wheel implementation. For example, while the wheel brake assembly 220 illustrated one caliper assembly 280 provided with each wheel 70 and each axle 60 including two manifold assemblies 250 provided with each axle 60, such that one of the two manifold assemblies 250 is provided with each wheel 70 of the axle 60 and is operably coupled with the caliper assembly 280 provided with the same wheel 70 of the axle 60, FIG. 12 illustrates another example of a wheel brake assembly 320 that includes only one manifold assembly 350 per axle 60.

The wheel brake assembly 320 is similar to the wheel brake assembly 220; therefore, like parts will be identified with like numerals in the 300 series, with it being understood that the description of the like parts of the wheel brake assembly 220 applies to the wheel brake assembly 320 unless otherwise noted.

The arrangement of the axle 60, the axle mount 62, the wheel 70, the tire 72, the wheel hub 80, and the braking disc 84 can be the same as described previously with respect to the wheel brake assembly 220. Further, a mounting bracket 330 and a caliper assembly 380 including at least one fluid line coupler 383 can be coupled with one another, coupled with the axle 60, and provided with each wheel 70 in the same manner as in the wheel brake assembly 220. The manifold assembly 350 of the wheel brake assembly 320 can also have the same components and configuration as the manifold assembly 250. However, the wheel brake assembly 320 differs from the wheel brake assembly 220 in that only one manifold assembly 350 is provided with each axle 60, rather than with each wheel 70, and thus the one manifold assembly 350 is spaced from the caliper assembly 380, rather than being directly mounted to or carried by the caliper assembly 380. Rather, the manifold assembly 350 can be mounted to the axle 60, such as near a central portion of the axle 60 by a separate mounting assembly 430 dedicated to mounting only the manifold assembly 350 to the axle 60.

Since the manifold assembly 350 is spaced from the caliper assembly 380, at least one fluid line 212, as described with respect to FIG. 3, extends between the manifold assembly 350 and the caliper assembly 380 to fluidly couple the manifold assembly 350, and thus also a brake fluid reservoir 370, with the caliper assembly 380, such as via the at least one fluid line coupler 383. Thus, in the case that both wheels 70 of the axle 60 include dedicated caliper assemblies 380, the single manifold assembly 350 mounted on the axle 60 is operably coupled with the caliper assemblies 380 of both wheels 70 coupled to the corresponding axle 60, via separate, dedicated fluid lines 212 extending between the manifold assembly 350 and each of the caliper assemblies 380. While the wheel brake assembly 320 affords somewhat less control of individual wheel 70 braking, as compared to the wheel brake assembly 220 with the manifold assembly 250 per wheel 70, the wheel brake assembly 320 still offers some improvement in braking control per axle 60, and with a cost savings of only needing one manifold assembly 250 per axle 60, rather than per wheel 70. Additionally, this design enables manufacture of the axle 60 with the manifold assembly 350 and the fluid lines 212 as a pre-assembled unit.

Further alternative configurations of the components of the wheel brake assemblies 220, 320 are contemplated within the scope of the present disclosure. For example, while the wheel brake assembly 220 illustrates the brake fluid reservoir 270 provided with the manifold assembly 250, such that the brake fluid reservoir 270 can be included with each wheel 70, and the wheel brake assembly 320 illustrates the brake fluid reservoir 370 provided with the manifold assembly 350, such that the brake fluid reservoir 370 is included with each axle 60, rather than with each wheel 70, such an arrangement of the brake fluid reservoir 270, 370 within the manifold assembly 250 is not limiting. In another non-limiting example, the brake fluid reservoir 270, 370 can be positioned remotely or spaced from the corresponding manifold assembly 250, 350 with which the brake fluid reservoir 270, 370 is fluidly coupled, such that the brake fluid reservoir 270 fluidly coupled with the manifold assembly 250 mounted at the wheel 70 is mounted with the wheel hub 80, but not directly within the manifold assembly 250, or even positioned away from the wheel 70, such as spaced from the wheel 70 on the axle 60, or such that the brake fluid reservoir 370 fluidly coupled with the manifold assembly 350 mounted on the axle 60 is mounted at a different location on the axle 60, or is mounted away from the axle 60 altogether.

In such cases, the brake fluid reservoir 270, 370 can be mounted at any suitable location of the trailer 50 spaced from or remote from the corresponding manifold assembly 250, 350 and fluidly coupled to the corresponding manifold assembly 250, 350, such as to the reservoir outlet 274 or to the pump inlet 261, by additional fluid lines 212, or by any suitable other type of fluid conduit or hose. Such positioning of the brake fluid reservoir 270, 370 spaced from the manifold assembly 250, 350 can locate the brake fluid reservoir 270, 370 at a position that is more easily accessible for servicing or filling by a user, and can also serve to isolate the brake fluid reservoir 270, 370 from vibration fatigue and/or heat that may occur with the axle 60 or the wheel 70.

The aspects described herein set forth a brake system for use with a trailer coupled with a tow vehicle that enables control of the brake system at each wheel of the trailer individually, such as by providing a wheel brake assembly including a manifold assembly for actuating a caliper assembly separately with each wheel of the trailer. Such a braking system allows for fine control of braking at each wheel, and can also allow for the use of such a brake system with various braking systems, including with anti-lock brake programs. In order to provide each of these parts with each of the wheels, the brake system allows for compact configuration of the wheel brake assembly components to fit with the available space with each wheel, such as by using a plurality of smaller pistons within a caliper assembly to meet braking pressure requirements with a smaller, more compact footprint for integration within a caliper housing of the brake system and to allow control at more separate caliper assemblies while still staying within the available power limitations of the tow vehicle for the trailer.

It will also be understood that various changes and/or modifications can be made without departing from the spirit of the present disclosure. By way of non-limiting example, although the present disclosure is described for use with a hydraulic brake system, it will be recognized that the principles for providing such brake actuators with each trailer wheel can be used in other configurations, including at other configurations or proportions of wheels on the trailer, or associated with other types of braking systems for the trailer.

To the extent not already described, the different features and structures of the various aspects can be used in combination with each other as desired. That one feature is not illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. While aspects of the disclosure have been specifically described in connection with certain specific details thereof, it is to be understood that this is by way of illustration and not of limitation. Reasonable variation and modification are possible within the scope of the forgoing disclosure and drawings without departing from the spirit of the disclosure, which is defined in the appended claims.

What is claimed is:

1. A trailed vehicle configured for coupling with a motor vehicle and adapted to be towed by the motor vehicle, the trailed vehicle comprising:
a frame;
at least one axle rotatably coupled to the frame and carrying a pair of wheels; and
a hydraulic brake system operably coupled with the motor vehicle and with each of the wheels of the trailed vehicle, the hydraulic brake system comprising:
a caliper assembly provided with each of the wheels of the trailed vehicle and having at least one piston, and
a manifold assembly provided with each of the wheels of the trailed vehicle and having a pump and a motor, wherein the manifold assembly is provided with and coupled to the caliper assembly.

2. The trailed vehicle of claim 1 wherein the manifold assembly is directly fluidly coupled with the caliper assembly.

3. The trailed vehicle of claim 2 wherein the manifold assembly is directly fluidly coupled with the at least one piston.

4. The trailed vehicle of claim 1 wherein the manifold assembly is fluidly coupled with the caliper assembly by at least one fluid line.

5. The trailed vehicle of claim 1 wherein the hydraulic brake system further comprises at least one controller operably coupled with the pumps provided with each of the wheels.

6. The trailed vehicle of claim 5 wherein the at least one controller is configured to deliver a pulse width modulation (PWM) signal to each manifold assembly.

7. The trailed vehicle of claim 6 wherein the delivered PWM signal is used to adjust a fluid pressure generated by the pumps.

8. The trailed vehicle of claim 6 wherein the at least one controller is configured to deliver separate PWM signals to each manifold assembly, independently of one another.

9. The trailed vehicle of claim 8 wherein the at least one controller is operably coupled with an anti-lock brake system of the motor vehicle.

10. The trailed vehicle of claim 5 wherein the at least one controller comprises multiple controllers, such that one controller is provided with each of the wheels.

11. A trailed vehicle configured for coupling with a motor vehicle and adapted to be towed by the motor vehicle, the trailed vehicle comprising:
a frame;
at least one axle rotatably coupled to the frame and carrying a pair of wheels; and
a hydraulic brake system operably coupled with the motor vehicle and with at least one of the wheels of the trailed vehicle, the hydraulic brake system comprising:
a caliper assembly provided with the at least one of the wheels of the trailed vehicle and having at least one piston, and
a manifold assembly provided with the at least one of the wheels of the trailed vehicle and having a pump and a motor, wherein the manifold assembly is provided with and directly coupled to the caliper assembly.

12. The trailed vehicle of claim 11 wherein the manifold assembly is directly fluidly coupled to the caliper assembly without intervening fluid lines.

13. The trailed vehicle of claim 11 wherein at least a portion of the manifold assembly is mounted to or at least partially carried by the caliper assembly.

14. The trailed vehicle of claim 11 wherein the manifold assembly further comprises a manifold and a brake fluid reservoir carried by the manifold.

15. The trailed vehicle of claim 14 wherein the pump is fluidly coupled to the brake fluid reservoir, and further wherein the pump is configured to draw brake fluid from the brake fluid reservoir and to selectively provide, via a valve, the brake fluid to the at least one piston of the caliper assembly and to be returned into the brake fluid reservoir.

16. A trailed vehicle configured for coupling with a motor vehicle and adapted to be towed by the motor vehicle, the trailed vehicle comprising:
a frame;
at least one axle rotatably coupled to the frame and carrying a pair of wheels; and
a hydraulic brake system operably coupled with the motor vehicle and with at least one of the wheels of the trailed vehicle, the hydraulic brake system comprising:
a caliper assembly provided with the at least one of the wheels of the trailed vehicle, the caliper assembly comprising:
a caliper housing, and
a plurality of pistons carried by the caliper housing, and
at least one manifold assembly provided with the at least one axle of the trailed vehicle and having a pump and a motor, wherein the manifold assembly is operably coupled to the caliper assembly such that the pump is fluidly coupled to each piston of the plurality of pistons.

17. The trailed vehicle of claim 16 wherein each piston of the plurality of pistons has a diameter that is less than a diameter of a standard 1600 PSI brake piston.

18. The trailed vehicle of claim 17 wherein the plurality of pistons have a combined, total working pressure of 600 PSI or less per caliper assembly configured for achieving required stopping distances of the trailed vehicle, and further wherein the plurality of pistons draw a combined total of 7 amps or less per caliper assembly.

19. The trailed vehicle of claim 18 wherein one caliper assembly is provided with each wheel of the pair of wheels and one manifold assembly is provided with the at least one axle, such that the one manifold assembly is operably coupled with the caliper assemblies of both wheels of the pair of wheels.

20. The trailed vehicle of claim 18 wherein one caliper assembly is provided with each wheel of the pair of wheels and the at least one manifold assembly provided with the at least one axle comprises two manifold assemblies provided with the at least one axle such that one manifold assembly is provided with each wheel of the pair of wheels and is operably coupled with the caliper assembly provided with the same wheel of the pair of wheels.
